(19) United States
(12) Patent Application Publication
(10) Pub. No.: US 2016/0358708 A1
(43) Pub. Date: Dec. 8, 2016

(54) Production of supermagnet

(71) Applicant: John Kissane, Far Hills, NJ (US)

(72) Inventor: John Kissane, Far Hills, NJ (US)

(21) Appl. No.: 14/544,022

(22) Filed: Nov. 17, 2014

(51) Int. Cl. H01F 41/02; G21B 1/11

(52) U.S. Cl. CPC H01F 41/0266; G21B 1/11; G21Y 2004/502

(57) ABSTRACT

My invention shows how to make super strong permanent magnets many times greater than those produced today. This is done by starting a nuclear reaction underground (By sandwitching a block of iron with two nuclear bombs exploding them) and digging up the resulting material. This material would then be used to produce super strong permanent magnets. These permanent magnets could then be used for the production of electricity. The process is alluded to by the conditions on the sun where magnetic fields are immense. Also by the fact that the nucleus of an iron atom has the greatest missing mass (mass defect) of any element. By making the mass defect greater using a nuclear reaction the magnetic properties of iron could be increased.

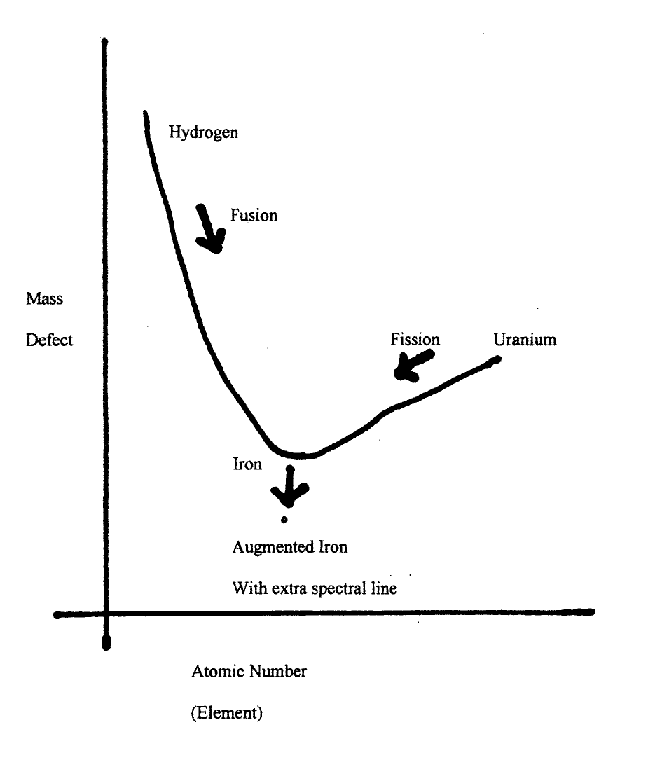

### CROSS-REFERENCE TO RELATED APPLICATIONS

Not Applicable

### STATEMENT REGUARDING FEDERALLY SPONSERED REASERCH OR DEVELOPMENT

Not Applicable

### REFERENCE TO SEQUENCE LISTINGS A TABLE, OR A COMPUTER PROGRAM LISTING COMPACT DISC APPENDIX

Not Applicable

### BACKGROUND OF THE INVENTION

Coal , Oil, Hydroelectric, and Nuclear Fission reactors are just some of the methods used to produce electricity for the cities of this country, and the world. What do they all have in common? They all use permanent magnets in the generators that produce electricity. These Magnets all require a lot of force to be rotated and produce electricity. But increase the strength of the permanent magnet inside the generator and much more electricity would be produced. If the magnet were strong enough generators could be run off small motors that would have the strength to rotate them because of the strength of the magnet inside. Magnets millions of times stronger then any produced up until now are possible.

That is what I am applying for a United States Patent for: a method to produce super strong permanent magnets for the production of electricity.

### BRIEF SUMMARY OF THE INVENTION

To produce a super strong permanent magnet an amount of iron would be placed in between two small nuclear fusion bombs and buried underneath the ground. These nuclear fusion bombs would then be Detonated and the resulting augmented iron would then be dug up from the dirt and separated. After which it would be melted down and used for its Super strong magnetic properties.

### BRIEF DESCRIPTION OF THE DRAWING

The drawing shows a graphical representation of the mass defect of an atom vs. the atomic number of the atom (The atomic number of the element). The mass defect is the difference between the mass of the atom and the sum of the masses of the nucleons and electrons. There is a difference between what is measured by weight and what is theoretically the mass of the elements atom (The sum of all its parts). That difference (The missing mass) is the mass defect. The mass defect increases to a maximum at the element iron. Furthermore iron is the most magnetic element.

### DETAILED DESCRIPTION OF THE INVENTION

With iron having the most missing mass in its nucleus (The greatest mass defect) and the fact that iron is the most magnetic element is important. My invention is the production of a super strong permanent magnet made from augmented elemental iron. Are super strong magnets possible? You need only look at the sun. There are magnetic storms on the sun millions of time greater in strength than any magnet on earth. Furthermore the outer corona of the sun exhibits light spectral lines that correspond to no known element. These spectral lines were once thought to be indicating an other element they called coronium. However they may not be an other element they may be just a smaller more dense nucleus of iron that gives off an extra spectral line. These extra spectral lines of the sun are important.

The conditions on the sun can be recreated on earth. This is known. Both nuclear fusion and fission are reactions that can be produced on earth. My invention is to sandwitch a block of elemental iron between two fusion bombs, bury it underground, explode them then dig up the resulting iron and use it for permanent magnets. Because small fusion bombs would be used

There would be no radioactivity. Furthermore the resulting iron with greater mass defect and density of its nucleus would be more magnetic. Permanent magnets millions of times greater than any produced before could be possible for the production of electricity.

What I claim as my invention is:

1. The process of producing super strong permanent magnets, this process and the products of it I claim as my invention, the process involves starting a nuclear reaction by exploding two small nuclear bombs that have a block of iron placed in between them underground, then digging the resulting augmented iron material and producing permanent magnets from it
